(19) United States
(12) Patent Application Publication
(10) Pub. No.: US 2016/0012015 A1
(43) Pub. Date: Jan. 14, 2016

(54) VISUAL FORM BASED ANALYTICS

(71) Applicants: Tuyen Tran, Nashville, TN (US); Stephen S. Hau, Nashville, TN (US); Alan Huffman, Nashville, TN (US); Patrick Clark, Nashville, TN (US)

(72) Inventors: Tuyen Tran, Nashville, TN (US); Stephen S. Hau, Nashville, TN (US); Alan Huffman, Nashville, TN (US); Patrick Clark, Nashville, TN (US)

(21) Appl. No.: 14/325,931

(22) Filed: Jul. 8, 2014

(51) Int. Cl. G06F 17/21; H04N 1/00; G06F 3/0487; G06F 3/0481; G06F 3/0484

(52) U.S. Cl. CPC G06F 17/21; G06F 3/0481; G06F 3/04817; G06F 3/04842; G06F 3/0487; H04N 1/00241

(57) ABSTRACT

A tablet based application provides a reporting and analytic tool for increasing data liquidity for quick and complete access allows query and analytic reporting using a screen form modeled after the paper form or other templated data arrangement used to enter the data. Users need not learn a new interface or form structure, but specify query data from the same format upon which the data was entered, facilitating association by visual cues from the form layout and arrangement of fields. Users generate custom, or ad-hoc reports by accumulating a set or reporting fields by visual selection and clicking on the form image representing the entry of the data sought, and multiple forms may be included in the same analytic or query request to focus on specific data items.

### BACKGROUND

Modern office trends often bring up the notion of a “paperless” office, in which all office workings are transacted in an electronic manner such as emails and application GUIs (Graphical User Interfaces). Mobile devices such as tablets, smartphones, and other portable devices lend themselves well to this environment. Many professionals, particular those in private practice such as doctors, lawyers, and dentists, however, have a refined set of forms that streamlines the practice and enjoys widespread acceptance among the staff as a working model. Attempts to implement an electronic infrastructure often meets with resistance due to entrenched paper systems and a staff familiarity with the status quo. Particularly with reports generation, where a query interface can be complex and difficult to learn, a human inertial factor to remain with a working mechanism can be difficult to overcome.

### SUMMARY

A tablet based application provides a reporting and analytic tool for increasing data liquidity for quick and complete access by performing query and analytic reporting using a screen form modeled after the paper form used to enter the data. Users need not learn a new interface or form structure, but rather specify query data from the same format upon which the data was entered, facilitating association by visual cues from the form layout and arrangement of fields. Users generate custom, or ad-hoc reports by accumulating a set or reporting fields by visual selection and clicking on the form image representing the data sought, and multiple forms may be included in the same analytic or query request to focus on specific data items.

Business enterprises of various sizes often employ forms in the normal course of business. The forms are often evolved over time to suit the course of business and the activities performed in pursuit of the business. Such forms therefore represent a finely tuned medium for conveying information in a manner that is efficient and streamlined to focus appropriate attention on important data items, and eliminate or minimize subordinate details. Office staff and professionals become accustomed to the forms, and develop a familiarity and manner of working with the forms. Any suitable workflow that is codifiable to include a templated arrangement of data items, such as paper forms, such as business processes, retail purchasing, shipping and receiving or academic selections (i.e. course registration) to name several, may be represented by the approach herein.

Enterprises often seek software applications for assisting with the activities of the business, for example billing, payroll and inventory, which are activities common to most businesses. More specialized applications may be developed for particular enterprises, to assist with activities that are more specific to the business at hand. However, vendors of such specialized applications face an increasingly smaller market audience depending on the specialization. Such vendors attempt to develop an all-encompassing, or “one-size-fits-all” approach to approximate the business practices of as many potential purchasers as possible. The broad approach often leaves potential customers weighing the benefits of their established forms against a generic interface promulgated by the software vendor for performing similar functions. It would be beneficial to develop a software application that allows the enterprise to continue to use their present forms, and avoid mandating relearning a generic interface in lieu of a workflow and GUI/form structure that has become engrained in the enterprise.

The workflow as encompassed by the disclosed approach represents a mental awareness and recognition of a spatial orientation of information as visually rendered on GUIs, paper forms, or other media employed in a workplace, enterprise, or systematic environment that adheres to established channels of information flow. The information flow and the manner of rendering on the GUIs, forms, etc. represents a mental model that individuals in the environment are accustomed to and work efficiently to.

Configurations herein are based, in part, on the observation that conventional analytics and query systems often employ a query interface that is based on field name designations, operands, and values of match terms corresponding to the desired information. Unfortunately, conventional approaches suffer from the shortcoming that such interfaces generally requires knowledge of a tabular structure of database tables where the data is stored, and interrelationships between multiple tables. A corresponding syntax, such as SQL (structured query Language) or an equivalent, is also required. Users or operators of these query engines require training in both the query language, and in the usage of the fields in the real-world system that the data models or defines. For example, in an office recordkeeping environment, office staff are familiar with a common forms used for data entry around the office, and the data which the forms represent. Such forms are typically used for populating data repositories, and usage is facilitated because the office staff knows the fields on the hardcopy form, the staff is familiar with the location and layout of the fields, and understands the usage of the field in the office throughput, i.e the “real world” usage of the form and the fields therein. Accordingly, configurations herein substantially overcome the above-described shortcomings by presenting a query interface that renders the actual form from which the data originated, and with which the office staff user is familiar with. The user selects fields by a point and click GUI that has the same appearance as the paper form from which the data was gathered, relying on positional and contextual knowledge of the form, rather than on the field names that represent the data. In this manner, a user may perform a query by simply clicking on the form fields and entering the values for the form fields of the data they seek in the query.

The discussion below includes an example invocation and sequence of the disclosed approach in a professional environment. The approach is applicable to any set of defined steps for retrieving and reporting information for subsequent review and/or consumption by a subsequent step in the environment. The approach identifies and captures the information items employed in a target environment, and transforms information items sought in a query request to a computer rendered version having the same rendered appearance that users in the environment have become accustomed to. The information items (typically data fields from a templated data entry form) are indexed, and cross referenced with other occurrences of the information items so that users may retrieve and employ the stored information elsewhere in the environment. The visual rendering of the information remains the same as in the preexisting environment and as gathered, stored, and reported using the disclosed approach, such that users observe a GUI rendered form having the same appearance as a preexisting paper form. In this manner, users are not forced to relearn and translate “new” fields or data items to corresponding preexisting fields, but rather retain previous training and work patterns because the visual cues and prompting provided by the preexisting forms is preserved.

In an example configuration depicted herein, a network conversant device or appliance such as a tablet facilitates a method of gathering form data, by selecting a reporting field based on visual cues from a rendered form, the rendered form emulating a paper counterpart form, and building a reporting criteria by selecting at least one reporting field and a condition based on the reporting field. An on-screen approach generates a rendering format by arranging the reporting fields, and renders a report including the arranged reporting fields based on the reporting criteria.

Alternate configurations of the invention include a multiprogramming or multiprocessing computerized device such as a multiprocessor, controller or dedicated computing device or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a non-transitory computer-readable storage medium including computer program logic encoded as instructions thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a computer readable medium such as an optical medium (e.g., CD-ROM), floppy or hard disk or other medium such as firmware or microcode in one or more ROM, RAM or PROM chips, field programmable gate arrays (FPGAs) or as an Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a computing environment suitable for use with configurations disclosed herein;

FIG. 2 is a block diagram of analytics processing in the environment of FIG. 1;

FIG. 3 is a screen rendering of the GUI showing form selection for query specification;

FIG. 4 is a rendering of the form selected in FIG. 3;

FIGS. 5a-5c show selection of reporting fields from a plurality of forms rendered as in FIG. 4;

FIG. 6 shows a screen for building a reporting criteria from the fields of FIGS. 5a-5c;

FIG. 7 shows results from the reporting criteria of FIG. 6;

FIG. 8 shows a histogram rendering of results of the reporting criteria as in FIG. 6;

FIG. 9 shows a tabular rendering of results based on the reporting criteria of FIG. 6;

FIG. 10 shows an alternate tabular rendering as in FIG. 9 arranged based on patient name;

FIG. 11 shows invoking a view to the original form from which a field originated; and

FIG. 12 shows a flowchart of query and analytics generation.

### DETAILED DESCRIPTION

A query and analytics application and device as disclosed herein performs database retrieval using an interface having the same graphical appearance and position as a familiar paper form that the user is accustomed to for entering the data. The user, typically an office staff member, performs analytics by simply selecting query fields from a screen that renders a form with fields in a known format, rather than by requiring entry of query name fields in a cryptic interface. In a business enterprise, forms are often developed for gathering information needed for various functions, operations and tasks in the enterprise. In a private practice, for example, professionals develop forms suited to their practice, and spend substantial time, effort and expense in training an office staff in the user of the forms for collecting data important to the various functions undertaken in the practice. A doctor's office may develop specific forms for patient intake, diagnosis, and treatment. The office staff becomes familiar with these forms, their layout, and what types of data is placed on the form. Using configurations herein, the same office staff may perform analytics and queries by entering query fields directly on a rendered on screen form in the same manner as the data is collected on the paper form. The application maps the user-entered fields on the rendered form to database fields, and performs any joins or indexing needed to identify the data entries sought. Analytics may be based on standard reports or ad-hoc forms that allow gathering of specific reporting fields. In the case of queries seeking data from multiple forms, multiple data collections corresponding to the forms may need to be interrogated to generate a result set of records. The application returns a result set meeting the query, and generates reports containing the requested information.

Configurations herein disclose an example of query and analytics generation using a physician's private practice and related office forms. An anesthesiologist practice is depicted, however any suitable enterprise employing an array of paper forms used for data entry would find the disclosed approach beneficial. In this manner, however, any suitable repeatable process for information retrieval and reporting, which can be defined in terms of a templated data rendering, such as a paper based business model, may be transformed to electronic forms without deviating from the visual cues afforded by the paper forms that the office staff and professionals have become accustomed to.

Other examples of a workflow using an established spatial layout of information items may also be recognized by the disclosed approach. An example may illustrate. Few forms are more widely known than the personal income tax statement embodied as Form 1040 of the IRS (Internal Revenue Service). This form and its counterpart dependent forms represents a highly interrelated and complex arrangement of information, and is navigated by many, both on paper and on its electronic counterparts from the IRS itself and from third party vendors. Users of these forms undoubtedly identify with a pattern of information that suits their personal situation which likely remains somewhat consistent from year to year. Such users rely on the visual cues afforded by the spatial arrangement of the fields, with right aligned numerical entries and indented sub calculations and computations amounts slightly indented from the right. Users are probably aware of a relative positioning of fields which defer to other forms, such as itemized deductions and capital gains. Imagine if a vendor attempted to market a software product that deviated from this well-established rendering of the user's personal financial data. Entry of the data and related calculations represent a workflow which is repeated in substantially the same manner year after year

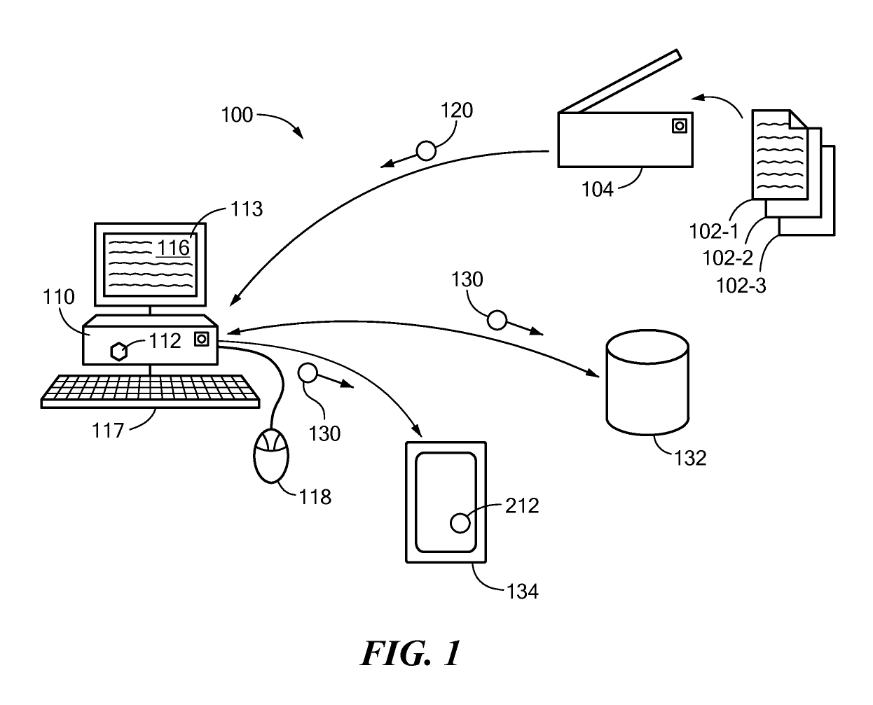

FIG. 1 is a context diagram of a computing environment suitable for use with configurations disclosed herein. FIG. 1 is a context diagram of a computing environment 100 suitable for use with configurations disclosed herein. Referring to FIG. 1, in a data entry environment 100, a plurality of paper forms 102-1 . . . 102-N (102 generally) are often employed for various tasks. In a doctor's office, for example, forms may exist for patient personal data, patient history, diagnosis, and treatment. There may also be other forms specific to particular courses of treatment, or for expanding on particular patient history conditions. In general, a busy office may employ a number of forms used in various circumstances, creating a complex set of interrelations and dependencies on forms employed in each particular case.

A scanner or other visual input device scans the paper form 102 to send a raw form image 120 to a form definition system 110. The form definition system 110, or server, may be a standard computer, such as a PC or MAC, operable to launch and execute a forms application 112. The form definition system 110 also includes a rendering device 114 having a visual display 113 for rendering a screen image, typically a GUI 116, a keyboard 117 and a pointing device 118. Forms entered by this application 112 are employed in queries and analytics performed and/or invoked by an application 212 on a mobile device 134, as discussed further below.

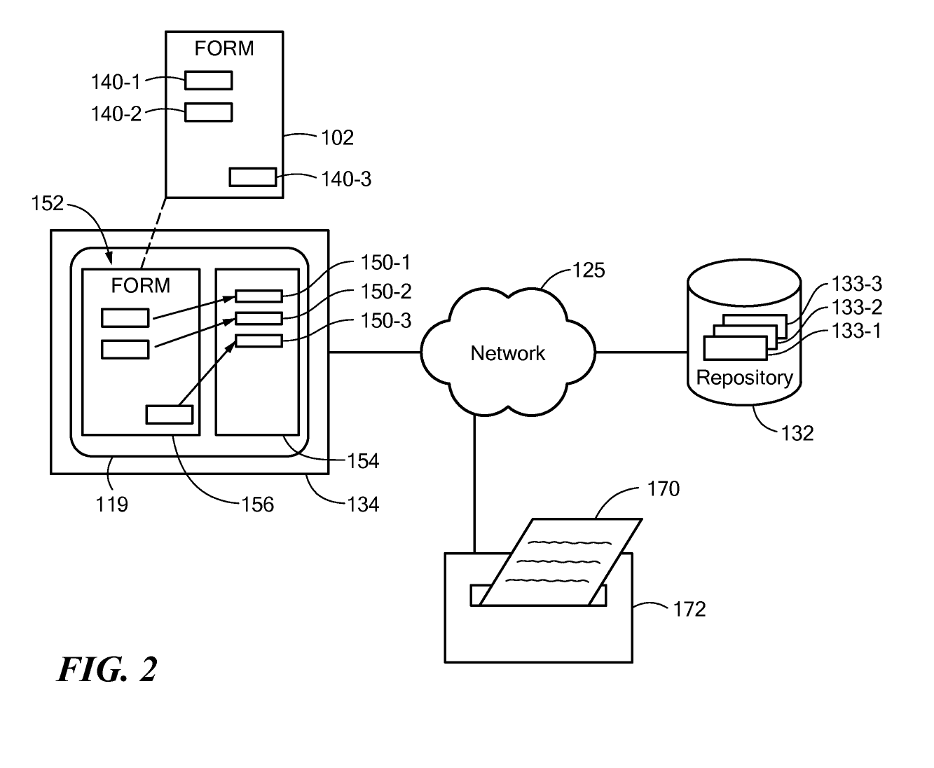

The application 212 employs the GUI 119 (FIG. 2) to receive user input, as discussed further below, for associating each of the fields on the form image 120 with metadata indicative of the fields to generate an electronic form (form) 130 suitable for processing, querying, and reporting data based on the form 130 as discussed further below. The form 130 may be stored in a storage repository 132, which may be a native mass storage device on the form definition system 110, and may also be emailed, printed, or otherwise transmitted around the office or enterprise environment as needed. The form 130 may also be rendered on a mobile device 134, such as tablet or phone, which may have a complementary application 212 for rendering the generated form 130 and receiving data for queries, reports, and other processing. The application 212 may also invoke or direct other servers, databases, and computing services to launch or respond to additional operations for rendering the desired report. In a particular configuration, the mobile device may be an IPAD® or IPHONE®, marketed commercially by Apple Computer, Inc. of Cupertino, Calif. In this manner, a complex arrangement of paper forms 102 representing an office or business workflow is transferred to the forms 130 suitable for entry, storage, and queries using a mobile device 134 or other suitable computing device. Generally, the mobile device 134 includes a user interface and a visual screen medium for rendering and receiving input, such as a field selection mechanism, typically a touch screen or pointer device control. Since the rendered forms 130 on the mobile device have the same appearance and content as the corresponding paper forms, a former paper system can be upgraded to mobile devices with minimal relearning, disruption, or reworking of office procedures.

FIG. 2 is a block diagram of analytics and query processing in the environment of FIG. 1. Referring to FIGS. 1 and 2, a network 125, which may be a LAN, WAN or other public or private wired or wireless interconnection such as the Internet, interfaces the mobile device 134 to the repository 132. The repository 132 accumulates a plurality of collections 133-1 . . . 133-3 (133 generally) of data stored therein, which may then be retrieved for query and analytic processing as described herein. Using the mobile device 134 or other suitable processing appliance (e.g. laptop, desktop, smartphone), a GUI 119 allows a user to select reporting fields 150-1 . . . 150-3 (150 generally) based on an on-screen rendered form 152 that is designed to emulate the counterpart paper form 102, and has fields 140-1 . . . 140-3 positioned similarly and in similar proportions such that visual cues are carried through to the rendered form 152. A selected fields window 154 gathers the reporting fields 150 for entry of a reporting criteria based on the reporting fields (discussed below). A resulting report 170 or analytic result is printed on an attached printer 172, rendered on the mobile device 134, or transmitted via the network 125 for remote rendering. Other suitable output rendering mediums may also be employed.

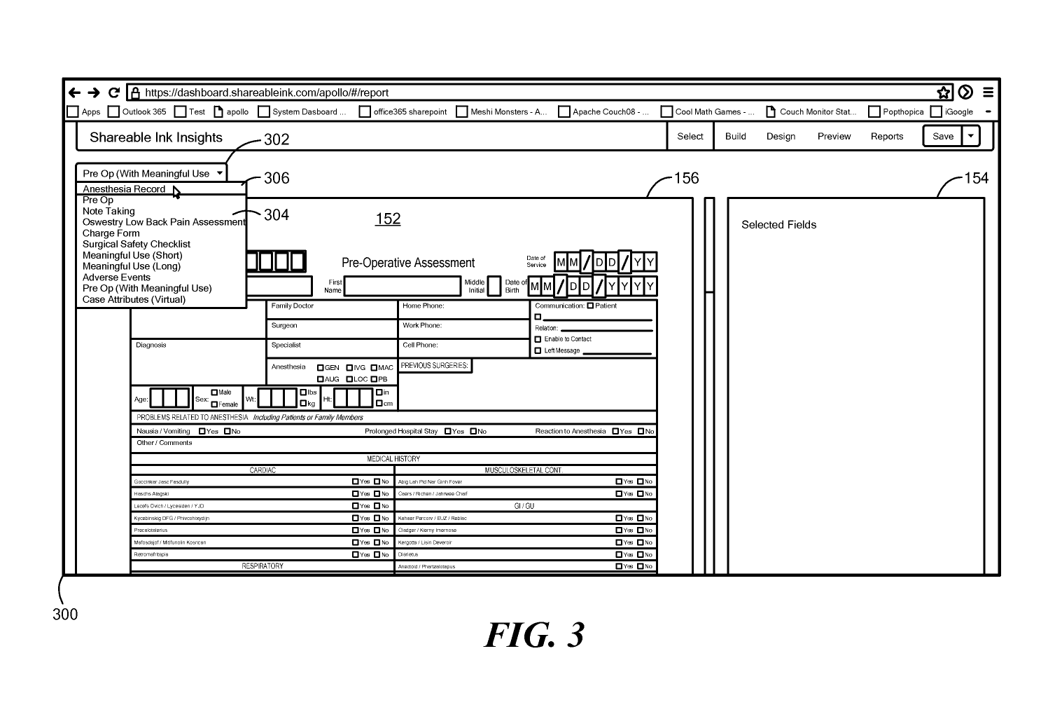

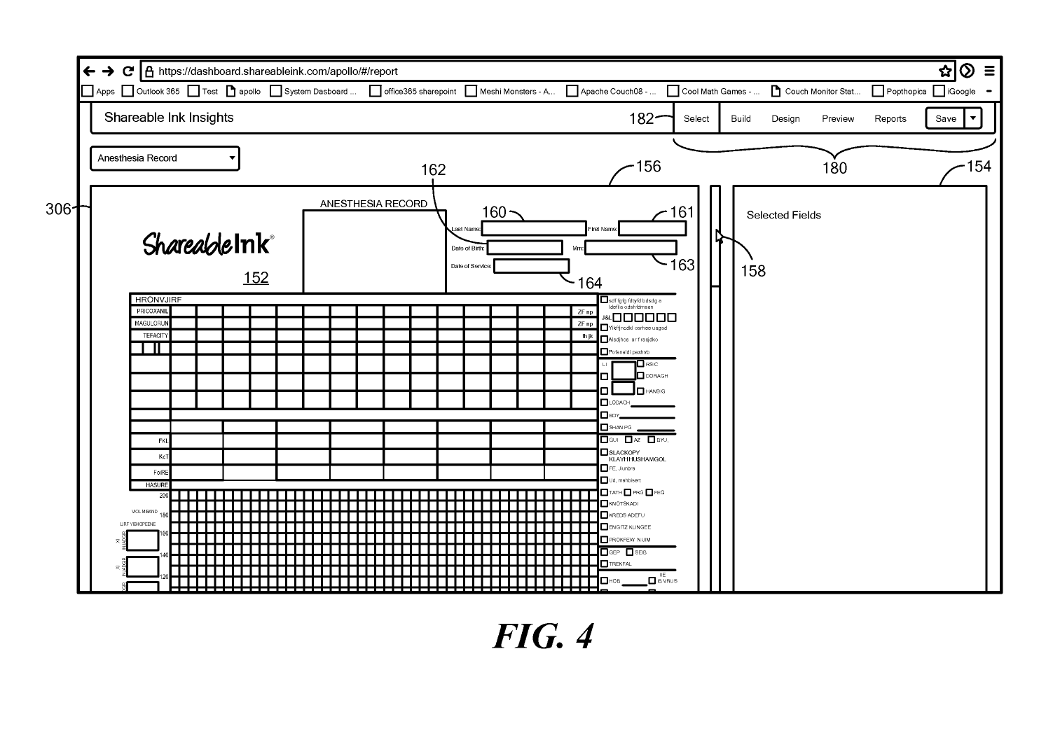

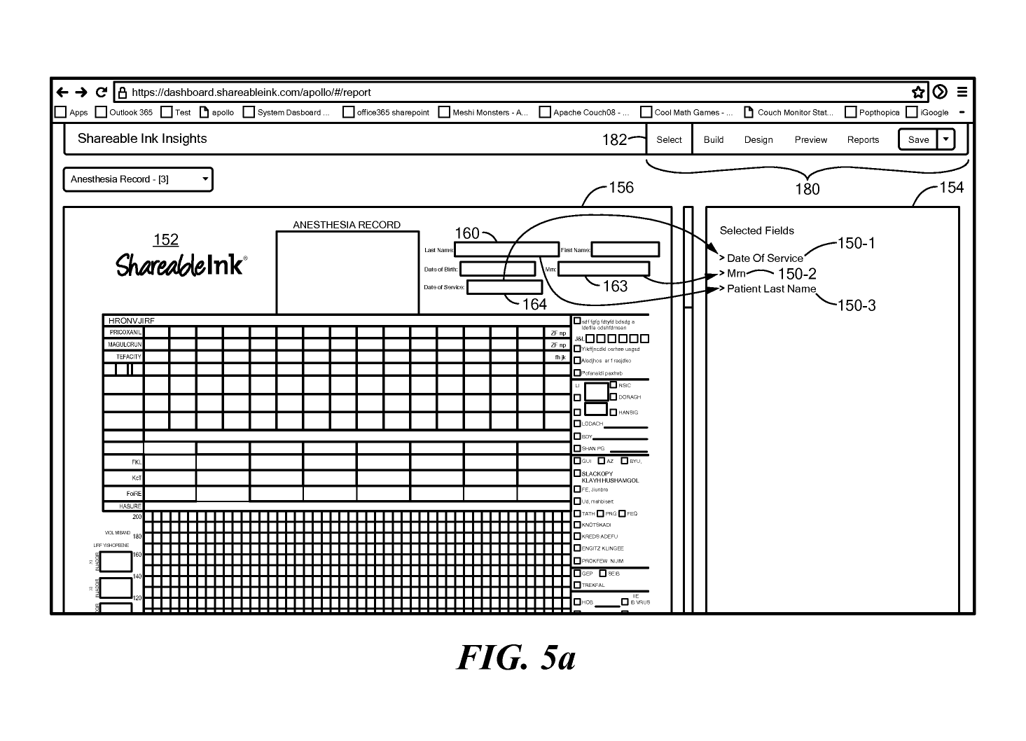

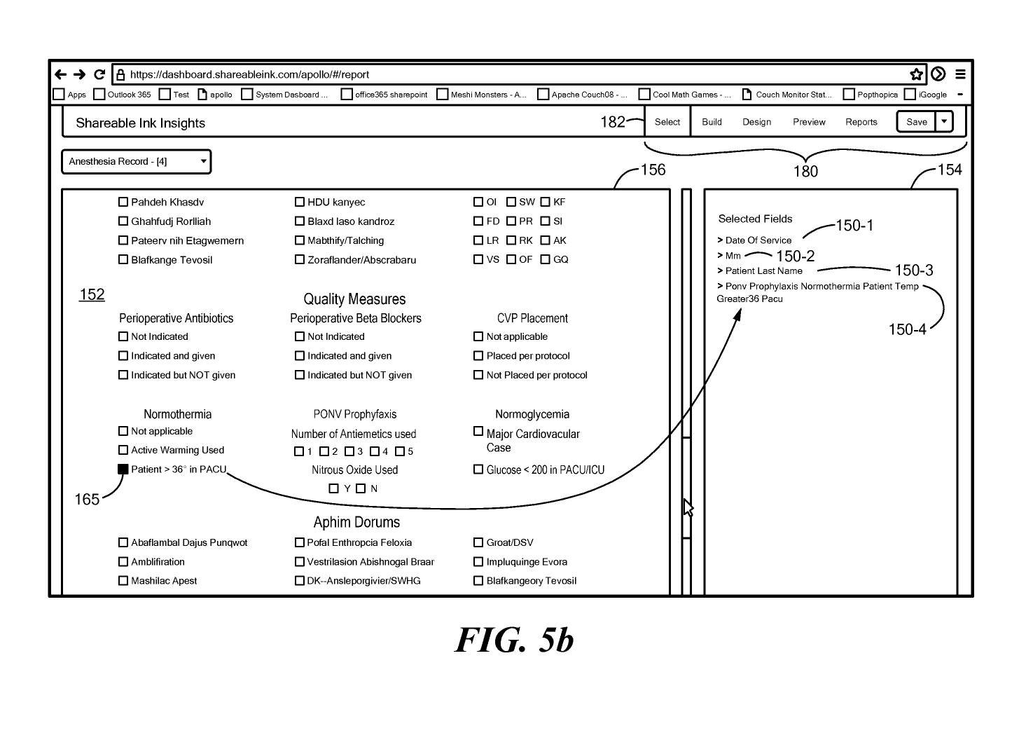

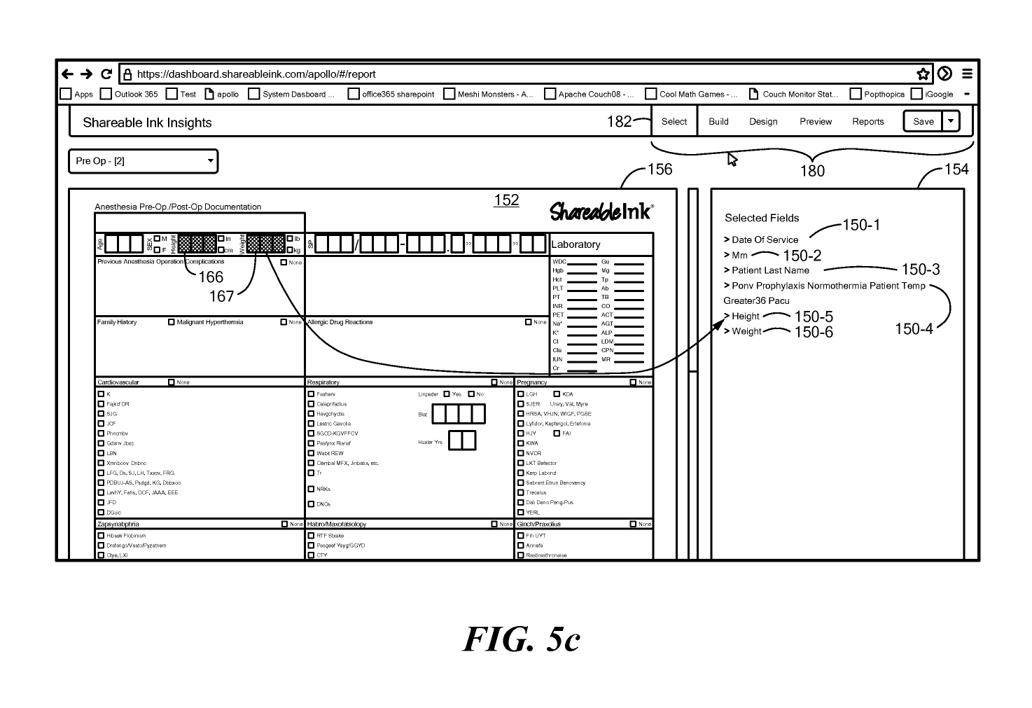

FIG. 3 is a screen rendering of the GUI showing form selection for query specification. Referring to FIGS. 2 and 3, a form selection screen 300 has a pulldown 302 of available forms 304 from which to select reporting fields 150. A selected form 306 will appear as the rendered form 152 in the forms window 156, and selected reporting fields added to the selected fields window 154, shown below with respect to FIGS. 4-5c. In the examples shown below in FIGS. 3-11, a medical office context is employed, depicted by an anesthesiologist practice and related forms 102. Other industries and/or professions could be employed to model the system, methods and apparatus disclosed herein. The illustrated renderings are examples and not intended to limit or restrict the disclosed configurations. The example renderings and reports shown depict Normothermia, a condition reflecting whether normal body temperature was maintained during the duration of anesthesia administration.

FIG. 4 is a rendering of the form selected in FIG. 3. Referring to FIGS. 2-4, the selected form 306 (“anesthesia record” in the example shown) appears. A rendered form 152 for selection is chosen by a selection button 182 in a row of query buttons 180. The rendered form 152 displays available fields for reporting on, including last name 160, first name 161, data of birth 162, Mrn (medical record number) 163, and date of service 164. A pointer 158 responsive to the pointing device 118 activates the available fields by hovering and clicking to move them into the selected fields window 154.

FIGS. 5a-5c show selection of reporting fields from a plurality of forms rendered as in FIG. 4; Referring to FIGS. 2-5c, FIG. 5a shows selection of the available fields 160, 163 and 164 as reporting fields 150-1, 150-2 and 150-3, shown by respective arrows. Using the screens depicted in FIGS. 5a-5c, the application 212 allows the user to select the reporting fields 150 by rendering a visual display of available fields based on a scanned version of the paper counterpart form 102, and receiving a pointer selection of an available fields, such that the available fields are activated by hovering of the pointer 158. The application 212 then adds the selected available field to a set of reporting fields 150, such that the set of reporting fields 150 is configured for storing a plurality of the available fields.

Selection of the available fields compiles a list of reporting fields 150-N in the selected fields window 154. FIG. 5b shows a scrolled down portion (lower half) of the rendered form 152, and shows selection of a Normothermia field 165, indicating maintenance of normal body temperature range during an anesthesia delivery. The Normothermia field 165, a Boolean (yes/no) type, is added to the selected fields window as reporting field 150-4.

FIG. 5c depicts selection of multiple forms 102, and shows rendered form 152′ pertaining to pre-op data. Available fields for height 166 and weight 167 are added to the selected fields window 154 as fields 150-5 and 150-6. A plurality of forms 102 are selectable as rendered forms 152, and the selected fields window 154 accumulates a set of reporting fields which may emanate from different collections 133 of data. Upon query execution, shown below, the application 212 performs the joins and indexing for traversing database relations to generate the desired analytics (query result) 160.

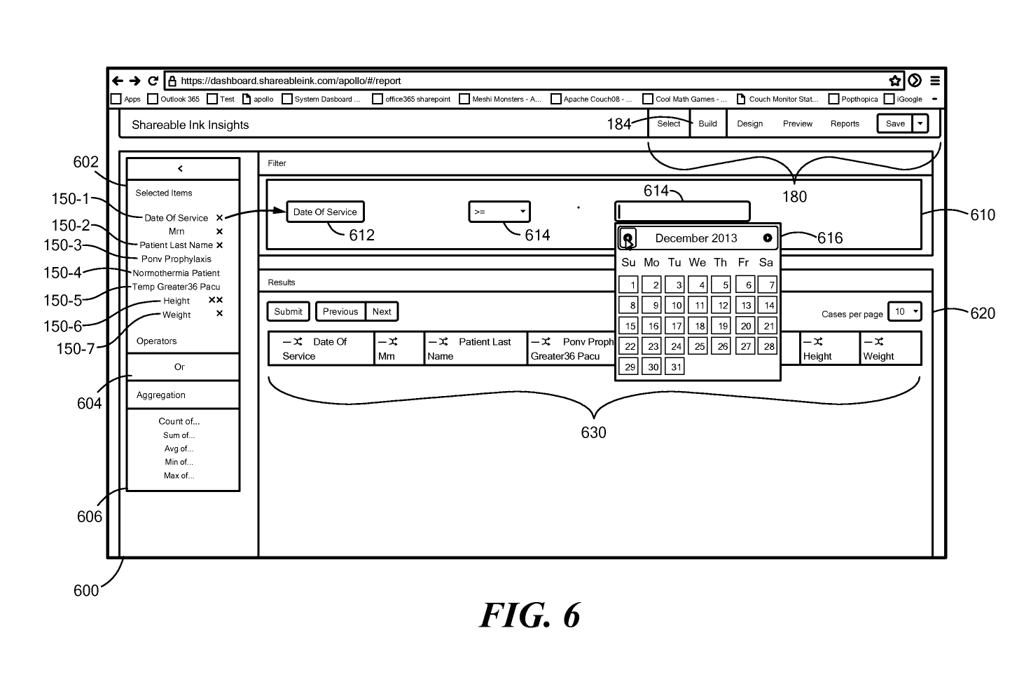

FIG. 6 shows a screen for building a reporting criteria from the fields of FIGS. 5a-5c. In the approach depicted, building the reporting criteria includes receiving a pointer selection of one or more reporting fields 150, and receiving a selection of a conditional operator, such that the conditional operator 614 is adapted for evaluation to determine inclusion in the rendered report 172. Once the reporting fields 150 are selected, the reporting criteria (selection filter) and output (results) formats can be selected from the reporting fields by entering query build mode via a build button 184 in the query buttons 180. Any fields used for either selection or rendering (output) of data, or both are represented in the reporting fields 150. Referring to FIGS. 2, 4 and 6, the selected fields 150 from the selected fields window 154 appear in a selected items window 602 on a reporting criteria screen 600. The reporting criteria screen 600 includes a selection window 610 and a results window 622. The selection window 610 defines conditional statements to determine entries for the report 170, and the results window defines the fields rendered and output arrangement (graph, tabular, etc.). Each of the reporting fields 150 appears in a fields header 630.

The example shown uses the date of service field 150-1, which appears as the current field 612 upon selection from the selected items window 602. A condition 614 defines a comparison or relation, such as equal to, greater than, less than, starts with, and others depending on appropriate comparisons for the data type of the current field 612. A match value 614 denotes a value for comparison, and may include a prompt 616 such as a calendar for a date field to facilitate selection. Any number of filter entries may be selected, as well as conjunctive or disjunctive associations between them via the operator button 604. Statistical functions such as summation and averages may also be selected via aggregation window 606.

The user may therefore build a reporting criteria based on a plurality of reporting fields 150, in which each of the reporting fields 150 originates from different forms 102. The application 212 is operable to combine each of a plurality of data collections 133 corresponding to the different forms for aggregating the reporting fields via joins and indexing, and, evaluating the conditions based on the aggregated reporting fields. In contrast to conventional approaches, therefore, which may model output data from a single form representing a single data file, the reporting fields 150 may span multiple data collections 133 with data correlated using joins or indexing. Depending on the structure and arrangement of the collections 133 storing the reporting fields 150, aggregating may include identifying dependencies between the reporting fields 150, and mapping the dependencies to a plurality of collections 133 of data including the reporting fields. For example, patient data may span multiple collections 133 indexed by name, social security number, and/or Mrn. Reported entries may need to gather reporting fields 150 from the collections 133-N joined by these key fields. The application 212 traverses the identified dependencies for generating entries reflecting the identified dependencies. In the example arrangement, traversing the dependencies may include performing a join based on fields in the collections having the reporting fields, depending on the underlying storage and form of the data collections 133. In an example configuration, the data collections 133 may be unstructured JSON (JavaScript Object Notation) database.

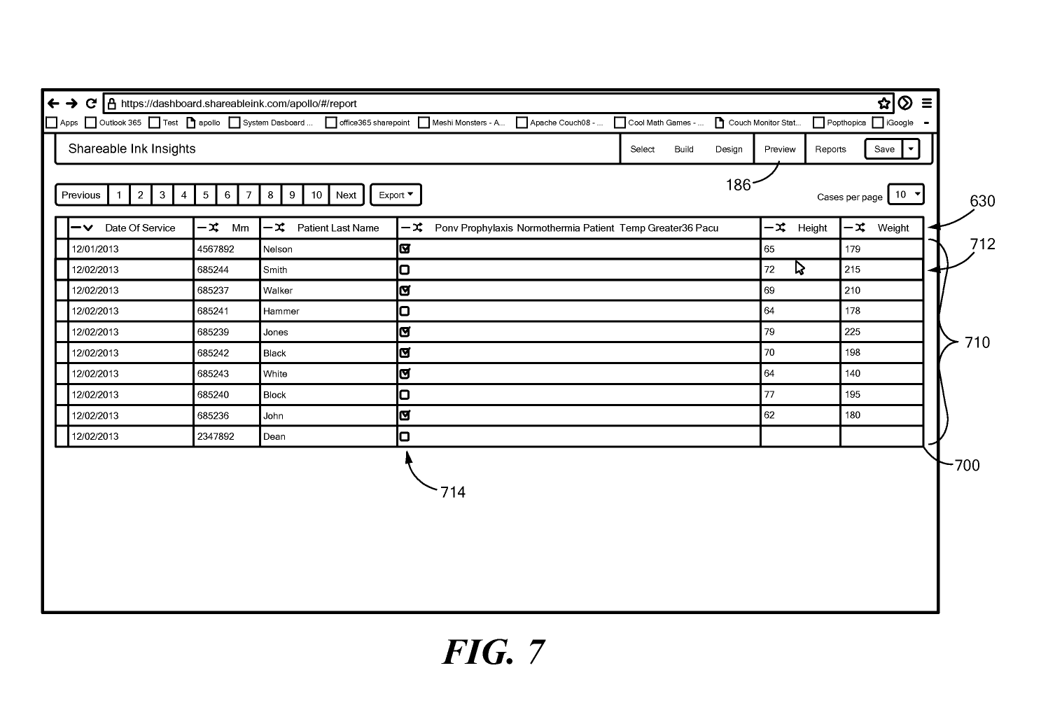

A results window 620 defines the output manner for the entries meeting the criteria specified by the filter 610. All reporting fields 150 or a subset may be selected in the fields header 630. In the example of FIG. 6, a tabular output format is shown, however other analytic reporting is available, such as histograms (FIG. 7, below), line graphs, circle graphs, and other formats depending on the type of data reported on.

FIG. 7 shows results from the reporting criteria of FIG. 6. Referring to FIGS. 6 and 7, a preview button 186 generates a preview window 700 including a plurality of entries 710 populated with the reporting fields 150 meeting the reporting criteria specified by the filter 610. For example, a Normothermia column 714 based on the n Normothermia status reporting field 150-4 indicates whether Normothermia was maintained, and the application 212 depicts a checkoff box to model the data as entered by the user, rather than a cryptic “1” or “0” to reflect a Boolean value. A selected field 712 may be employed for further refinement and drill-down operations.

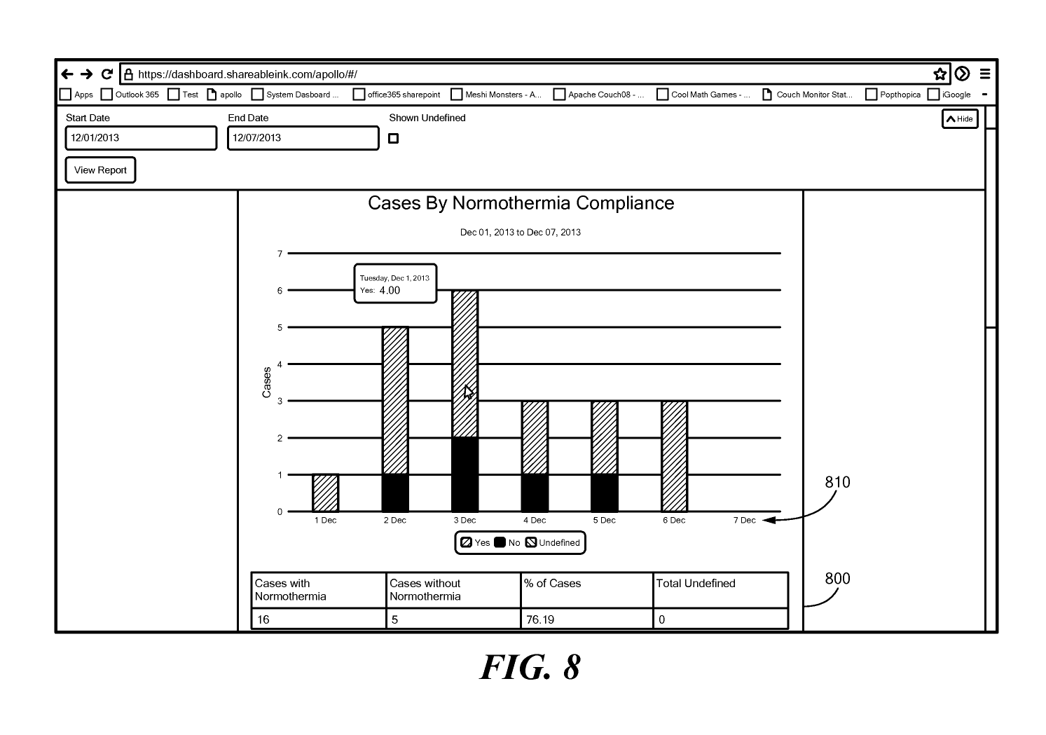

FIG. 8 shows a histogram rendering of results of the reporting criteria as in FIG. 6. Referring to FIG. 6-8, a variety of reporting and summary rendering options are available, as depicted in a histogram rendering 800 of the date of service 150-1 and Normothermia status 150-4.

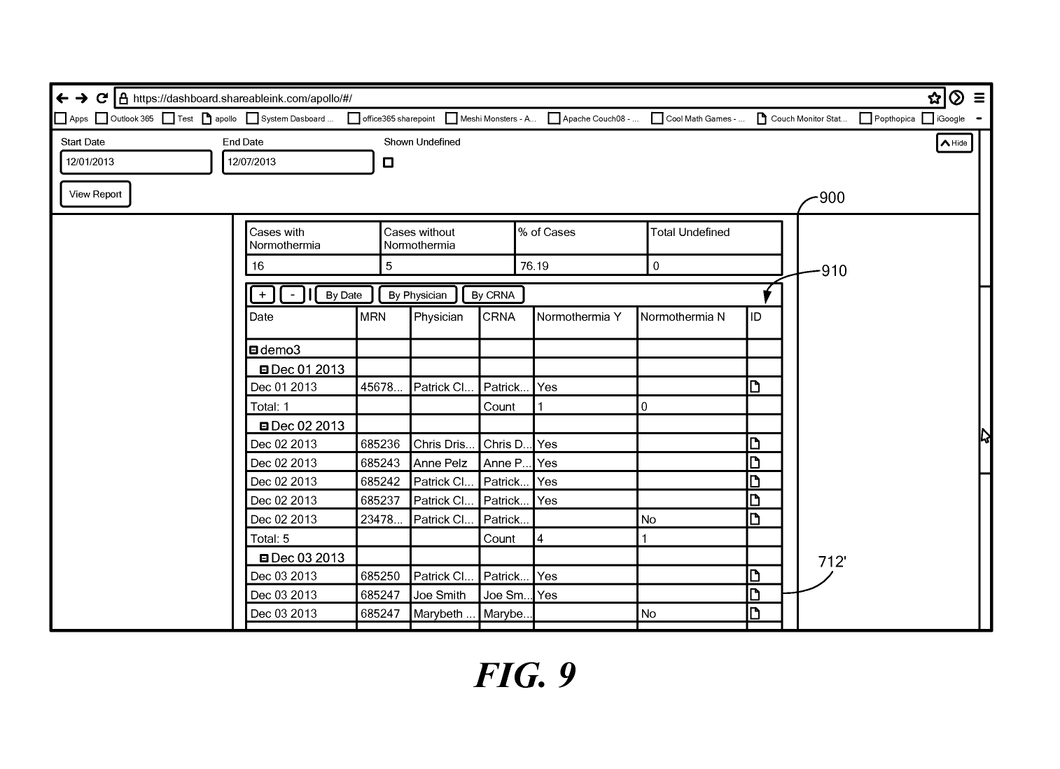

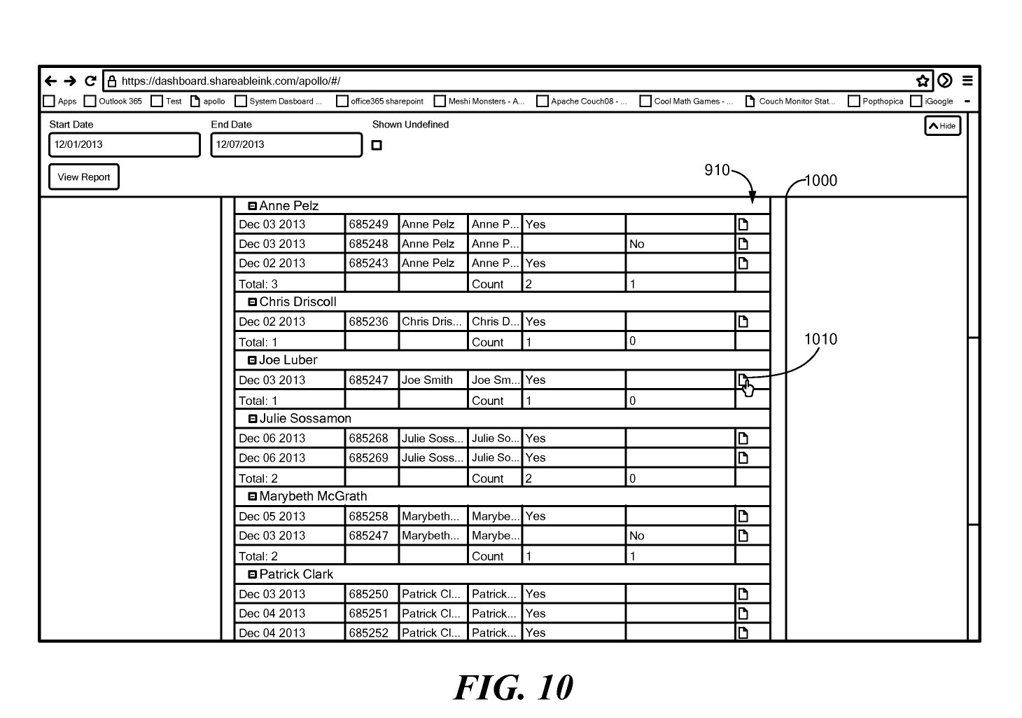

FIG. 9 shows a tabular rendering of results based on the reporting criteria of FIG. 6, and FIG. 10 shows an alternate tabular rendering as in FIG. 9 arranged based on patient name. Referring to FIGS. 7 and 9-10, FIG. 9 shows a report on the data of FIG. 7 arranged by date of treatment. Highlighted entry 712 is shown as report entry 712′. FIG. 10 shows a similar rendering 1000 arranged by patient name. In both cases a forms column 910 allows viewing of the form 102 from which the data originated.

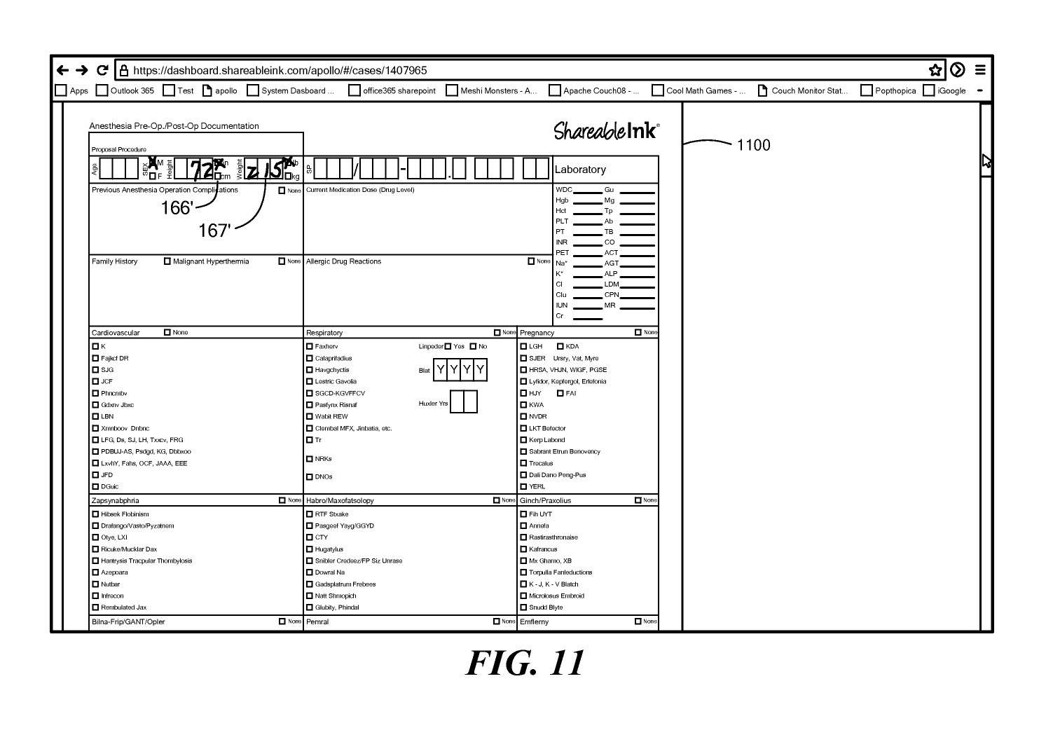

FIG. 11 shows invoking a view to the original form from which a field originated. Referring to FIGS. 5c and 9-11, invocation of the forms icon 1010 renders the form view 1100 of FIG. 11. The form view 1100 shows the originating form including fields 166′ (height) and 167′ (weight) used to populate the reporting fields 166 and 167 of FIG. 5c. FIG. 11 shows a scan rendering of the paper form 102 employed. Alternate approaches may depict a normalized form with fields electronically populated from the preciously entered data, i.e. reflecting the typed values, rather than the handwritten scan. In either case, the forms view 1100 shows the originating form so that the user may draw an association to the paper form 102 from which the reporting fields 150-6, 150-7 were derived.

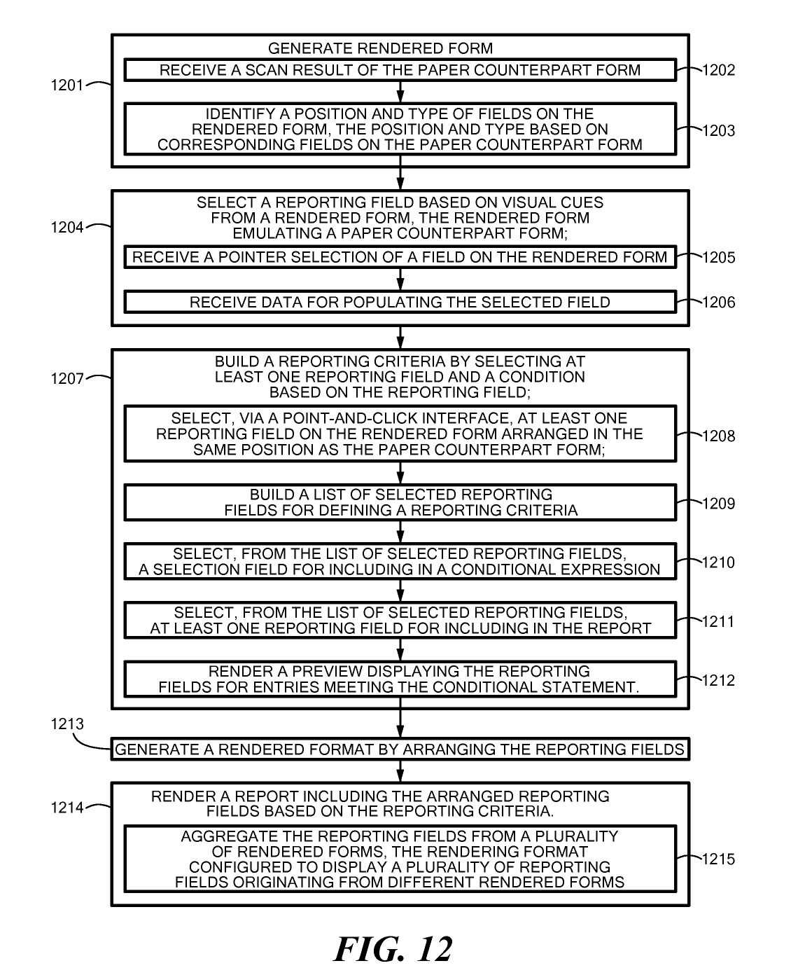

FIG. 12 shows a flowchart of query and analytics generation via configurations proposed herein. Referring to FIGS. 1-12, in configurations herein, a query or analytic system generates a rendered form 152, as depicted at step 1201, to respond to requests based on a native paper form 102. This includes, at step 1202, receiving a scan result of the paper counterpart form 102 corresponding to the data and/or report sought, and at step 1203, identifying a position and type of fields on the rendered form 152, such that the position and type are based on corresponding fields on the paper counterpart form.

The application 212 receives user input for selecting a reporting field 150 based on visual cues from the rendered form 152, in which the rendered form 102 emulates the paper counterpart form 102, as depicted at step 1204. This includes receiving a pointer selection of a field on the rendered form 152, typically from a pointer device 118, and receiving data for populating the selected field, as shown at step 1206. A plurality of fields from the rendered form 152 may be selected for the reporting fields 152 to be used in the reporting phase, either for selection or output.

The application 212 receives user input for building a reporting criteria by selecting at least one reporting field and a condition based on the reporting field, as depicted at step 1207. The user builds the reporting criteria selecting, via a point-and-click interface, at least one reporting field 150 on the rendered form 152 arranged in the same position as the paper counterpart form 102, as shown at step 1208. The user builds a list of selected reporting fields for defining a reporting criteria in the selected fields window 154, as depicted at step 1209. The user selects, from the list of selected reporting fields, a selection field for including in a conditional statement, as disclosed at step 1210, and selects, from the list of selected reporting fields, at least one reporting field for including in the report, as depicted at step 1211. The conditional field and output field may be the same, or may be different, and multiple fields and conditional expressions may be entered depending on the scope of the data sought in the report 170.

The application 212 renders a report preview displaying the reporting fields of entries meeting the conditional statement, as depicted at step 1212, and receives input for generating a rendering format by arranging the reporting fields, as shown at step 1213. The report format may take one of several report mediums, such as the tabular or histogram examples shown, and may include various arrangements of the reporting fields 150, such as columnar placement. The system 212 renders the report 170 including the arranged reporting fields 150 based on the reporting criteria. This may include aggregating the reporting fields from a plurality of rendered forms, in which the rendering format is configured to display a plurality of reporting fields originating from different rendered forms and/or data collections 133, as depicted at step 1215.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of gathering form data, comprising:
selecting a reporting field based on visual cues from a templated arrangement of information;
building a reporting criteria by selecting at least one reporting field and a condition based on the reporting field;
generating a rendering format by arranging the reporting fields; and
rendering a report including the arranged reporting fields based on the reporting criteria.

2. The method of claim 1 wherein the templated arrangement of information is based on a rendered form, the rendered form emulating a paper counterpart form employed in a repeatable process.

3. The method of claim 1 further comprising:
identifying a spatial arrangement of the information items, the spatial arrangement defining a mental model retained by users; and
rendering a report based on the spatial arrangement for emulating the mental model in subsequent presentation to the users.

4. The method of claim 1 wherein the templated arrangement of information defines a spatial layout of the information items on an electronic rendering.

5. The method of claim 2 further comprising:
selecting an arranged reporting field from the rendering format; and
viewing the paper counterpart form that the selected reporting field originated from.

6. The method of claim 2 further comprising generating the rendered form by:
receiving a scan result of the paper counterpart form;
identifying a position and type of fields on the rendered form, the position and type based on corresponding fields on the paper counterpart form;
receiving a pointer selection of a field on the rendered form; and
receiving data for populating the selected field.

7. The method of claim 2 further comprising building the reporting criteria by:
selecting, via a point-and-click interface, at least one reporting field on the rendered form arranged in the same position as the paper counterpart form;
building a list of selected reporting fields for defining a reporting criteria;
selecting, from the list of selected reporting fields, a selection field for including in a conditional statement;
selecting, from the list of selected reporting fields, at least one reporting field for including in the report; and
rendering a report displaying the reporting fields of entries meeting the conditional statement.

8. The method of claim 7 wherein selecting the reporting fields further comprises:
rendering a visual display of available fields based on a scanned version of the paper counterpart form;
receiving a pointer selection of an available fields, the available fields activated by hovering of an icon from a pointer device; and
adding the selected available field to a set of reporting fields, the set of reporting fields configured for storing a plurality of the available fields.

9. The method of claim 7 wherein building the reporting criteria further comprises:
receiving a pointer selection of a reporting field; and
receiving a selection of a conditional operator, the conditional operator adapted for evaluation to determine inclusion in the rendered report.

10. The method of claim 7 further comprising aggregating the reporting fields from a plurality of rendered forms, the rendering format configured to display a plurality of reporting fields originating from different rendered forms.

11. The method of claim 7 further comprising building a reporting criteria based on a plurality of reporting fields, each of the reporting fields originating from different forms; and
combining each of a plurality of data collections corresponding to the different forms for aggregating the reporting fields; and
evaluating the conditions based on the aggregated reporting fields.

12. The method of claim 10 wherein aggregating the reporting fields further comprises:
identifying dependencies between the reporting fields;
mapping the dependencies to a plurality of collections of data including the reporting fields; and
traversing the identified dependencies for generating entries reflecting the identified dependencies.

13. The method of claim 12 wherein traversing the dependencies further comprises performing a join based on fields in the collections having the reporting fields.

14. A network appliance for analytic reporting, comprising:
a user interface for receiving a selection a reporting field based on visual cues from a rendered form, the rendered form emulating a paper counterpart form;
a screen selection mechanism for building a reporting criteria by selecting at least one reporting field and a condition based on the reporting field;
the user interface further configured for generating a rendering format by arranging the reporting fields; and
an interface to a data repository for generating and rendering a report including the arranged reporting fields based on the reporting criteria.

15. The appliance of claim 14 wherein the user interface is further configured to:
select an arranged reporting field from the rendering format; and
view the paper counterpart form that the selected reporting field originated from.

16. The appliance of claim 14 further comprising a screen configured to:
display a scan result of the paper counterpart form;
identify a position and type of fields on the rendered form, the position and type based on corresponding fields on the paper counterpart form;
receive a pointer selection of a field on the rendered form; and
receive data for populating the selected field.

17. The appliance of claim 15 further comprising a screen configured to:
select, via a point-and-click interface, at least one reporting field on the rendered form arranged in the same position as the paper counterpart form;
build a list of selected reporting fields for defining a reporting criteria;
select, from the list of selected reporting fields, a selection field for including in a conditional statement;
select, from the list of selected reporting fields, at least one reporting field for including in the report; and
render a report displaying the reporting fields of entries meeting the conditional statement.

18. The appliance of claim 17 wherein the user interface is configured to:
render a visual display of available fields based on a scanned version of the paper counterpart form;
receive a pointer selection of an available fields, the available fields activated by hovering of an icon from a pointer device; and
add the selected available field to a set of reporting fields, the set of reporting fields configured for storing a plurality of the available fields.

19. The appliance of claim 17 where the interface is configured to aggregate a plurality of collections corresponding to reporting fields from a plurality of rendered forms, the rendering format configured to display a plurality of reporting fields originating from different rendered forms.

20. The appliance of claim 19 wherein aggregating the reporting fields further comprises:
identifying dependencies between the reporting fields;
mapping the dependencies to a plurality of collections of data including the reporting fields; and
traversing the identified dependencies for generating entries reflecting the identified dependencies.

21. The appliance of claim 20 wherein traversing the dependencies further comprises performing a join based on fields in the collections having the reporting fields.

22. The appliance of claim 17 wherein the user interface is configured to generate a request to:
build a reporting criteria based on a plurality of reporting fields, each of the reporting fields originating from different forms;
combine each of a plurality of data collections corresponding to the different forms for aggregating the reporting fields; and
evaluate the conditions based on the aggregated reporting fields.

23. A computer program product on a non-transitory computer readable storage medium having instructions that, when executed by a processor, perform a method of generating analytics, comprising:
selecting a reporting field based on visual cues from a rendered form, the rendered form emulating a paper counterpart form;
building a reporting criteria by selecting at least one reporting field and a condition based on the reporting field;
generating a rendering format by arranging the reporting fields; and
rendering a report including the arranged reporting fields based on the reporting criteria.
